(19) United States
(12) Patent Application Publication
(10) Pub. No.: US 2017/0316475 A1
(43) Pub. Date: Nov. 2, 2017

(54) METHOD AND SYSTEM FOR IDENTIFYING INVOICES THAT ARE PAID THROUGH A PERSONAL FINANCIAL MANAGEMENT AND BILL PAYMENT SYSTEM

(71) Applicant: Intuit Inc., Mountain View, CA (US)

(72) Inventors: Elangovan Shanmugam, Cupertino, CA (US); Sean McCluskey, Redwood City, CA (US); Jesse Aaron Axelowitz, San Francisco, CA (US); Ashwin Singh Khurana, Fremont, CA (US); Michael J. Seilnacht, Fremont, CA (US)

(73) Assignee: Intuit Inc., Mountain View, CA (US)

(21) Appl. No.: 15/140,131

(22) Filed: Apr. 27, 2016

(51) Int. Cl. G06Q 30/04; G06Q 20/14

(52) U.S. Cl. CPC G06Q 30/04; G06Q 20/14

(57) ABSTRACT

Financial transaction data representing financial transactions associated with a user of a personal financial management and bill payment system is obtained from, or through, the personal financial management and bill payment system. The financial transaction data is then analyzed to identify payee data representing the payees of financial transactions. The payee data is then compared with business user identification data representing users of a business invoicing system. If a match is found between a payee represented in the payee data and a business user represented in the business invoicing system, the associated payment is identified and processed as an invoice payment and the business user of the business invoicing system is provided the capability to provide invoicing data representing invoices generated by the business user to the user of the personal financial management and bill payment system through the personal financial management and bill payment system.

### BACKGROUND

Currently, several personal financial management and bill payment systems are available to help a personal financial management and bill payment system user, or any authorized party acting on behalf of a personal financial management and bill payment system user, obtain financial transaction data representing financial transactions conducted by the user, process/analyze the financial transaction data, display categorized financial transaction data, generate financial transaction reports, generate bills due and payment due reports, and/or make manual, semi-automated, and/or automatic bill payments through the personal financial management and bill payment system.

Some personal financial management and bill payment systems help users manage their finances and/or track their expenditures/financial transactions by providing a centralized interface with banks, credit card companies, and various other financial institutions, for electronically identifying and categorizing the user's financial transaction data. Currently, personal financial management and bill payment systems typically obtain electronic financial transaction data, such as payee data, payment amount data, transaction date data, etc. via communication with banks, credit card providers, or other financial institutions, using electronic data transfer systems, or various other systems for obtaining/transferring financial transaction data.

Personal financial management and bill payment systems have proven to be very popular and valuable tools for the users of the personal financial management and bill payment systems. This is largely due to the fact that using a personal financial management and bill payment system, a user can obtain most, if not all, of their financial transaction data from multiple sources and this data can be processed and analyzed in its entirety to create in depth, and very complete reports and features. Some personal financial management and bill payment systems include a payment due report/display generation feature. Typically, a payment due report includes a listing of payments due within a defined period of time, such as a month, which require the user's attention. In some cases, the user of the personal financial management and bill payment system is also provided the capability to make the listed payments on a manual, semi-automatic, i.e., with user approval, or automatic, basis. Users of personal financial management and bill payment systems have come to rely on these payment due reports and often use the reports, and payment features, to pay the vast majority of their bills through the personal financial management and bill payment system.

As used herein, the term “bill” includes, but is not limited to, an account statement or other potentially recurring cost and financial transaction. Examples of bills include, but are not limited to: rent payments, utility payments, credit card payments, grocery store payments, vehicle costs, etc. In contrast to the term “bill”, herein the term “invoice” includes, but is not limited to, costs associated with a specific product and/or service provided by a business and for which full payment is requested via the invoice document. A given invoice is therefore typically a non-recurring expense and/or is associated with specific products and/or services rendered, even though multiple, and even recurring identical, invoices can be generated by the same business for the same customer if multiple products and/or services, even the same products and/or services, are provided.

Herein the terms “payment” and/or “payment due” are used interchangeably and include any payment owed by a first party, i.e., payor party, to a second party, i.e., a payee party. Consequently, as used herein, the terms “payment” and/or “payment due” include both “bills” and “invoices.”

Currently, users of bill payment features offered through a personal financial management and bill payment system can pay both bills and invoices by simply entering payee data, amount data, routing data, and payment date data, and, importantly, without designating a given payment as a payment associated with a bill or with an invoice. In addition, financial transaction data obtained by, or through, a personal financial management and bill payment system often includes financial transaction data representing financial transactions performed by, or on behalf, of a user through another entity such as another financial institution account. Often, this financial transaction data also fails to indicate whether a given payment is associated with a bill or with an invoice.

Consequently, users of personal financial management and bill payment systems can pay either bills or invoices without designating which type of payment is being made. This is unfortunate given the differences between “bills” and “invoices” in terms of how these two types of payments should ideally be identified, categorized, and processed by the personal financial management and bill payment system. In short, it would be very beneficial to identify any invoices and, once identified, provide a feature whereby identified invoices generated by a business invoicing system, and/or one or more financial institutions providing financial transaction data to the personal financial management and bill payment system could be identified and then properly processed and integrated into the personal financial management and bill payment system.

This represents a significant and long standing technical problem in the financial management system, payment processing, and invoicing arts. In particular, currently available personal financial management and bill payment systems do not provide a mechanism for automatically identifying, or distinguishing, invoices, invoice data, and/or invoice payments and then properly processing and integrating identified invoices into a personal financial management and bill payment system.

As a result of the situation described above, many invoices are currently treated as bills and businesses generating invoices for their customers are not provided a mechanism to get invoices in front of their customers, have their invoices processed as the invoices they are, and/or integrate their invoices into the customers payment routine offered through the personal financial management and bill payment systems. This situation exists today despite the fact that most businesses are business users of sophisticated business invoicing systems and/or business financial management systems that include business invoicing features.

Consequently, there is a long standing technical problem in the financial management system, payment processing, and invoicing arts in that currently available personal financial management and bill payment systems do not provide a mechanism for automatically identifying, or distinguishing, invoices, invoice data, and/or invoice payments and then properly processing and integrating identified invoices into a personal financial management and bill payment system. What is needed is a method and system for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system.

### SUMMARY

In accordance with one embodiment, financial transaction data representing financial transactions associated with a user is obtained from, or through, a personal financial management and bill payment system. The financial transaction data is then analyzed to identify payee data representing the payees of financial transactions. The payee data is then compared with business user identification data representing users of a business invoicing system. If a match is found between a payee represented in the payee data and a business user represented in the business invoicing system, the associated payment is identified and processed as an invoice payment and the business user of the business invoicing system is provided the capability to provide invoicing data representing invoices generated by the business user to the user of the personal financial management and bill payment system through the personal financial management and bill payment system.

Consequently, disclosed herein is a method and system for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system. Therefore, disclosed herein is an efficient, effective, and dynamically adaptable technical solution to the long standing technical problem in the financial management system, payment processing, and invoicing arts of automatically identifying, or distinguishing, invoices and/or invoice payments and then properly processing and integrating identified invoices into a personal financial management and bill payment system.

In accordance with one embodiment, a personal financial management and bill payment system is provided to users of the personal financial management and bill payment system. In accordance with one embodiment, access to personal financial management and bill payment system user financial transaction data representing financial transactions associated with users of a personal financial management and bill payment system is obtained.

In accordance with one embodiment, the personal financial management and bill payment system user financial transaction data is stored in a partitioned personal financial management and bill payment system user financial transaction data section of a memory.

In accordance with one embodiment, the personal financial management and bill payment system user financial transaction data associated with a given user is analyzed to identify payee data included in the financial transaction data associated with the user. In one embodiment, the payee data represents one or more payees associated with the user financial transactions associated with the user represented by the portion of the user financial transaction data associated with the user. In one embodiment, the payee data is stored in a partitioned user payee data section of a memory.

In accordance with one embodiment, a business invoicing system is provided to business users of the business invoicing system. In accordance with one embodiment, access to business invoicing system business user identification data associated with the business invoicing system is obtained. In one embodiment, the business user identification data represents business users of the business invoicing system. In one embodiment, the business user identification data is stored in a partitioned business user identification data section of a memory.

In accordance with one embodiment, the payee data and business user identification data are analyzed to determine if a payee represented in the payee data matches a business user of the business invoicing system represented in the business user identification data. In accordance with one embodiment, a first payee represented in the payee data that matches a first business user of the business invoicing system represented in the business user identification data is identified. In one embodiment, the first payee is a payee associated with first financial transaction data representing a first financial transaction included in the personal financial management and bill payment system user financial transaction data associated with the user.

In accordance with one embodiment, status data associated with the first financial transaction data representing the first financial transaction is then transformed to first invoice related financial transaction data. In accordance with one embodiment, the first invoice related financial transaction data is then processed as invoice related financial transaction data.

In accordance with one embodiment, the first business user of the business invoicing system is also provided the capability to provide invoicing data representing invoices generated by the first business user of the business invoicing system to the user of the personal financial management and bill payment system through the personal financial management and bill payment system.

The embodiments disclosed herein provide a method and system for automatically identifying, or distinguishing, invoices, invoice data, and/or invoice payments and then properly processing and integrating identified invoices into a personal financial management and bill payment system and providing a business the capability to provide their invoices to customer users of the personal financial management and bill payment system through the personal financial management and bill payment system. Therefore, disclosed herein is an efficient, effective, and dynamically adaptable technical solution to the long standing technical problem in the financial management system, payment processing, and invoicing arts of automatically identifying, or distinguishing, invoices and/or invoice payments and then properly processing and integrating identified invoices into a personal financial management and bill payment system.

However, the disclosed method and system for identifying invoices that are paid through a personal financial management and bill payment system does not encompass, embody, or preclude other forms of innovation in the area of automated financial transaction bill payment processing and invoicing. In addition, the disclosed method and system for identifying invoices that are paid through a personal financial management and bill payment system is not related to any fundamental economic practice, fundamental data processing practice, mental steps, or pen and paper based solution. In fact, the disclosed embodiments are directed to providing solutions to the relatively new problems associated with the automatic processing and display of electronic financial transaction data obtained from multiple sources, making electronic bill payments, and the management and processing of large amounts of data, i.e., “big data.” Consequently, the disclosed method and system for identifying invoices that are paid through a personal financial management and bill payment system is not directed to, does not encompass, and is not merely, an abstract idea or concept.

In addition, the disclosed method and system for identifying invoices that are paid through a personal financial management and bill payment system provides for significant improvements to the technical fields of electronic transaction data processing, invoicing, financial transaction categorization, information dissemination, data processing, data management, data filtering and mining, automatic electronic bill payment, and user experience.

In addition, the disclosed method and system for identifying invoices that are paid through a personal financial management and bill payment system provides for the entry, processing, and dissemination, of only relevant portions of data; thereby eliminating unnecessary data analysis and correction before resources are allocated to processing, and/or correcting, faulty/irrelevant data, and/or the faulty/irrelevant data is further transmitted/distributed. Consequently, using the disclosed method and system for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing the method and system for identifying invoices that are paid through a personal financial management and bill payment system.

In addition, by allowing for the integration of invoices and invoice data into a personal financial management and bill payment system, the disclosed method and system for identifying invoices that are paid through a personal financial management and bill payment system helps users of the personal financial management and bill payment system identify and pay their invoices. This, in turn, helps avoid the reissuance and repeated transmission of payment due reminders and for the entry, processing, and dissemination, of redundant invoice data; thereby eliminating unnecessary data analysis before resources are allocated to processing, and/or correcting, redundant reminders data and the redundant reminder data is further transmitted/distributed. Consequently, using the disclosed method and system for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing the method and system for identifying invoices that are paid through a personal financial management and bill payment system.

### BRIEF DESCRIPTION OF THE DRAWINGS

FIG. 1 is a high level functionality-based block diagram of a hardware and production environment for identifying invoices that are paid through a personal financial management and bill payment system, in accordance with one embodiment; and

FIG. 2 is a flow chart representing one example of a generalized process for identifying invoices that are paid through a personal financial management and bill payment system, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### Term Definitions

Herein, the term “personal financial management and bill payment system” includes, but is not limited to, the following: computing system, desktop system, mobile system, and/or wearable device implemented, and/or online, and/or web-based, storage based, persistence based, personal financial transaction aggregation and/or processing systems, services, packages, programs, modules, or applications; computing system, desktop system, mobile system, and/or wearable device implemented, and/or online, and/or web-based, storage based, persistence based, personal financial management and budgeting systems, services, packages, programs, modules, or applications; computing system, desktop system, mobile system, and/or wearable device implemented, and/or online, and/or web-based, storage based, persistence based, personal data management systems, services, packages, programs, modules, or applications; computing system, desktop system, mobile system, and/or wearable device implemented, and/or online, and/or web-based, storage based, persistence based, personal accounting systems, services, packages, programs, modules, or applications; personal electronic tax preparation systems, services, packages, programs, modules, or applications; and various other personal electronic data management systems, services, packages, programs, modules, or applications, whether known at the time of filling, or as developed later.

Specific examples of personal financial management and bill payment systems include, but are not limited to the following: Mint™, available from Intuit, Inc. of Mountain View, Calif.; Mint Online™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Herein, the term “business invoicing system” includes, but is not limited to, any system through which a business can generate, and/or submit, and/or process invoices requesting payment for products and/or services provided by the business to customers of the business. Therefore, the term “business invoicing system” includes, but is not limited to, the following: computing system, desktop system, mobile system, and/or wearable device implemented, and/or online, and/or web-based, storage based, persistence based, business accounting and/or invoicing systems, services, packages, programs, modules, or applications; computing system, desktop system, mobile system, and/or wearable device implemented, and/or online, and/or web-based, storage based, persistence based, business financial transaction aggregation and/or processing systems, services, packages, programs, modules, or applications; computing system, desktop system, mobile system, and/or wearable device implemented, and/or online, and/or web-based, storage based, persistence based, business financial management and budgeting systems, services, packages, programs, modules, or applications; computing system, desktop system, mobile system, and/or wearable device implemented, and/or online, and/or web-based, storage based, persistence based, business management systems, services, packages, programs, modules, or applications; business electronic tax preparation systems, services, packages, programs, modules, or applications; and various other business electronic data management systems, services, packages, programs, modules, or applications, whether known at the time of filling, or as developed later.

Specific examples of “business invoicing systems” include, but are not limited to, the following: QuickBooks™, available from Intuit, Inc. of Mountain View, Calif.; QuickBooks Online™, available from Intuit, Inc. of Mountain View, Calif.; QuickBooks Self-Employed™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Herein, the terms “software system” and “software application” are used interchangeably and can be, but are not limited to, any data management system implemented on a computing system, accessed through one or more servers, accessed through a network, accessed through a cloud, and/or provided through any system or by any mechanism and/or process, as discussed herein, and/or as known in the art at the time of filing, and/or as developed after the time of filing, that gathers/obtains data, from one or more sources and/or has the capability to analyze at least part of the data.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the terms “mobile computing system” and “mobile device” are used interchangeably and include, but are not limited to the following: a smart phone; a cellular phone; a digital wireless telephone; a tablet computing system; a notebook computing system; any portable computing system; a two-way pager; a Personal Digital Assistant (PDA); a media player; an Internet appliance; devices worn or carried by a user; or any other movable/mobile device and/or computing system that includes components that can execute all, or part, of any one of the processes and/or operations as described herein.

Herein, the term “production environment” includes the various components, or assets, used to deploy, implement, access, and use, a given software system as that software system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the software system in the production environment such as a data center, a cloud computing environment, a dedicated hosting environment, and/or one or more other computing environments in which one or more assets used by the application in the production environment are implemented; one or more computing systems or computing entities used to implement at least part of the software system in the production environment; one or more virtual assets used to implement at least part of the software system in the production environment; one or more supervisory or control systems, such as hypervisors, or other monitoring and management systems used to monitor and control assets and/or components of the production environment; one or more communications channels for sending and receiving data used to implement at least part of the software system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the software system in the production environment; one or more databases used to store data in the production environment; one or more internal or external services used to implement at least part of the software system in the production environment; one or more backend systems, such as backend servers or other hardware used to process data and implement at least part of the software system in the production environment; one or more software modules/functions used to implement at least part of the software system in the production environment; and/or any other assets/components making up an actual production environment in which at least part of the software system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the software system.

In various embodiments, one or more cloud computing environments are used to create, and/or deploy, and/or operate at least part of the software system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given software system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

Herein, the term “party,” “user,” “user consumer,” and “customer” are used interchangeably to denote any party and/or entity that interfaces with, and/or to whom information is provided by, the method and system for identifying invoices that are paid through a personal financial management and bill payment system described herein, and/or a person and/or entity that interfaces with, and/or to whom information is provided by, the method and system for identifying invoices that are paid through a personal financial management and bill payment system described herein, and/or a legal guardian of person and/or entity that interfaces with, and/or to whom information is provided by, the method and system for identifying invoices that are paid through a personal financial management and bill payment system described herein, and/or an authorized agent of any party and/or person and/or entity that interfaces with, and/or to whom information is provided by, the method and system for identifying invoices that are paid through a personal financial management and bill payment system described herein. For instance, in various embodiments, a user can be, but is not limited to, a person, a commercial entity, an application, a service, and/or a computing system.

Herein, the term “financial transaction” includes, but is not limited to, any interaction between two or more parties involving the transfer, or re-categorization, of funds between the parties. Herein, the term “financial transaction data” includes, but is not limited to, electronic data representing at least one financial transaction and that is capable of being processed by a processor, and/or stored in a memory, and/or is otherwise machine readable.

Herein, the term “product and/or service provider” includes any party and/or entity that is associated with a user through a financial transaction represented by financial transaction data.

As used herein, the term “bill” includes, but is not limited to, an account statement or other potentially recurring cost and financial transaction. Examples of bills include, but are not limited to: rent payments, utility payments, credit card payments, grocery store payments, vehicle costs, etc.

In contrast to the term “bill”, herein the term “invoice” includes, but is not limited to costs associated with a specific product and/or service provided by a business and for which full payment is requested via the invoice document. A given invoice is therefore typically a non-recurring expense and/or is associated with specific products and/or services rendered, even though multiple, and even recurring identical, invoices can be generated by the same business for the same customer if multiple products and/or services, even the same products and/or services, are provided.

Herein the terms “payment” and/or “payment due” are used interchangeably and include any payment owed by a first party, i.e., payor party, to a second party, i.e., a payee party. Consequently, as used herein, the terms “payment” and/or “payment due” include both “bills” and “invoices.”

### DETAILED DISCLOSURE

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The embodiments described herein provide an efficient, effective, and dynamically adaptable technical solution to the long standing technical problem in the financial management system, payment processing, and invoicing arts of automatically identifying, or distinguishing, invoices and/or invoice payments and then properly processing and integrating identified invoices into a personal financial management and bill payment system.

In one embodiment, a personal financial management and bill payment system is provided using one or more computing systems.

As noted above, herein, the term “personal financial management and bill payment system” includes, but is not limited to, the following: computing system, desktop system, mobile system, and/or wearable device implemented, and/or online, and/or web-based, storage based, persistence based, personal financial transaction aggregation and/or processing systems, services, packages, programs, modules, or applications; computing system, desktop system, mobile system, and/or wearable device implemented, and/or online, and/or web-based, storage based, persistence based, personal financial management and budgeting systems, services, packages, programs, modules, or applications; computing system, desktop system, mobile system, and/or wearable device implemented, and/or online, and/or web-based, storage based, persistence based, personal data management systems, services, packages, programs, modules, or applications; computing system, desktop system, mobile system, and/or wearable device implemented, and/or online, and/or web-based, storage based, persistence based, personal accounting systems, services, packages, programs, modules, or applications; personal electronic tax preparation systems, services, packages, programs, modules, or applications; and various other personal electronic data management systems, services, packages, programs, modules, or applications, whether known at the time of filling, or as developed later.

As noted above, specific examples of personal financial management and bill payment systems include, but are not limited to the following: Mint™, available from Intuit, Inc. of Mountain View, Calif.; Mint Online™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

In accordance with one embodiment, one or more processors associated with one or more computing systems are utilized to obtain access to personal financial management and bill payment system user financial transaction data representing financial transactions associated with users of the personal financial management and bill payment system.

As noted above, herein, the term “financial transaction” includes, but is not limited to, any interaction between two or more parties involving the transfer, or re-categorization, of funds between the parties. Herein, the term “financial transaction data” includes, but is not limited to, electronic data representing at least one financial transaction and that is capable of being processed by a processor, and/or stored in a memory, and/or is otherwise machine readable.

In accordance with one embodiment, one or more processors associated with one or more computing systems are utilized to obtain access to personal financial management and bill payment system user financial transaction data associated with users of the personal financial management and bill payment system by obtaining access to user account data associated with the users of the personal financial management and bill payment system.

In various embodiments, the personal financial management and bill payment system user financial transaction data includes, but is not limited to, payments made to a payee party on behalf of the user of the personal financial management and bill payment system through the personal financial management and bill payment system, and/or through any account offered by any financial institution of payment system provider.

In one embodiment, the personal financial management and bill payment system user financial transaction data is verified using one or more verification mechanisms and/or processes as discussed herein, and/or as known in the art at the time of filing, and/or as developed or becomes known after the time of filing.

In one embodiment, the personal financial management and bill payment system user financial transaction data obtained is stored in a partitioned personal financial management and bill payment system user financial transaction data section of a memory.

In accordance with one embodiment, one or more processors associated with one or more computing systems are used to analyze the personal financial management and bill payment system user financial transaction data associated with a given user to identify user payee data included in the financial transaction data associated with the user. In one embodiment, the user payee data represents one or more payees associated with the user financial transactions associated with the user represented by the portion of the user financial transaction data associated with the user.

In one embodiment, the user payee data is verified using one or more verification mechanisms and/or processes as discussed herein, and/or as known in the art at the time of filing, and/or as developed or becomes known after the time of filing.

In one embodiment, the user payee data is stored in a partitioned user payee data section of a memory.

In accordance with one embodiment, a business invoicing system is provided to business users of the business invoicing system.

As noted above, herein, the term “business invoicing system” includes, but is not limited to, any system through which a business can generate, and/or submit, and/or process invoices requesting payment for products and/or services provided by the business to customers of the business. Therefore, the term “business invoicing system” includes, but is not limited to, the following: computing system, desktop system, mobile system, and/or wearable device implemented, and/or online, and/or web-based, storage based, persistence based, business accounting and/or invoicing systems, services, packages, programs, modules, or applications; computing system, desktop system, mobile system, and/or wearable device implemented, and/or online, and/or web-based, storage based, persistence based, business financial transaction aggregation and/or processing systems, services, packages, programs, modules, or applications; computing system, desktop system, mobile system, and/or wearable device implemented, and/or online, and/or web-based, storage based, persistence based, business financial management and budgeting systems, services, packages, programs, modules, or applications; computing system, desktop system, mobile system, and/or wearable device implemented, and/or online, and/or web-based, storage based, persistence based, business management systems, services, packages, programs, modules, or applications; business electronic tax preparation systems, services, packages, programs, modules, or applications; and various other business electronic data management systems, services, packages, programs, modules, or applications, whether known at the time of filling, or as developed later.

Specific examples of “business invoicing systems” include, but are not limited to, the following: QuickBooks™, available from Intuit, Inc. of Mountain View, Calif.; QuickBooks Online™, available from Intuit, Inc. of Mountain View, Calif.; QuickBooks Self-Employed™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Currently, personal financial management and bill payment systems and business invoicing systems are typically distinct software systems operated and/or used by two distinct parties, e.g., a customer of a business and an owner of a business, respectively. Therefore, currently, personal financial management and bill payment systems and business invoicing systems typically operate in isolation from each other, even when they are offered by the same personal financial management and bill payment system and business invoicing system provider.

As a specific illustrative example, in one embodiment, the personal financial management and bill payment system used by a customer of a business, or other user, could be a personal financial transaction management system such as Mint™, available from Intuit, Inc. of Mountain View, Calif. In this specific illustrative example, a business invoicing system, used by a business user, could be a business invoicing system such as QuickBooks™, available from Intuit, Inc. of Mountain View, Calif. As seen in this specific illustrative example, both the personal financial management and bill payment system and the business invoicing system are offered by the same software system provider, i.e., in this specific case, Intuit, Inc. of Mountain View, Calif. Consequently, according to one embodiment, in this specific illustrative example, the personal financial management and bill payment system and the business invoicing system are provided the opportunity to cross pollinate and cross confirm supported data. This approach has several unique advantages.

In some embodiments, the business invoicing system is part of, and/or a feature of, a parent small business financial management system.

In accordance with one embodiment, one or more processors associated with one or more computing systems are utilized to obtain access to business invoicing system business user identification data associated with the business invoicing system. In one embodiment, the business user identification data represents business users of the business invoicing system. In one embodiment, the business user identification data is stored in a partitioned business user identification data section of a memory.

In one embodiment, the business user identification data is verified using one or more verification mechanisms and/or processes as discussed herein, and/or as known in the art at the time of filing, and/or as developed or becomes known after the time of filing.

As noted above, as used herein, the term “bill” includes, but is not limited to, an account statement or other recurring cost and financial transaction. Examples of bills include, but are not limited to: rent payments, utility payments, credit card payments, grocery store payments, vehicle costs, etc.

As also noted above, in contrast to the term “bill”, herein the term “invoice” includes, but is not limited to costs associated with a specific product and/or service provided by a business and for which full payment is requested via the invoice document. A given invoice is therefore typically a non-recurring expense and/or is associated with specific products and/or services rendered, even though multiple, and even recurring identical, invoices can be generated by the same business for the same customer if multiple products and/or services, even the same products and/or services, are provided.

As also noted above, herein the terms “payment” and/or “payment due” are used interchangeably and include any payment owed by a first party, i.e., a customer or payor party, to a second party, i.e., a business or payee party. Consequently, as used herein, the terms “payment” and/or “payment due” include both “bills” and “invoices.”

As also noted above, currently, a user of a personal financial management and bill payment system can pay both bills and invoices by simply entering payee data, amount data, routing data, and payment date. Consequently, users can pay either bills or invoices without designating which type of payment is being made. This is unfortunate given the differences between “bills” and “invoices.” in terms of how these two types of payments should ideally be identified, categorized, and processed by the personal financial management and bill payment system. In short, it would be very beneficial to identify any invoices that are paid and, once identified, provide a feature whereby identified invoices generated by a business invoicing system, and/or one or more financial institutions providing financial transaction data to the personal financial management and bill payment system could be identified and then properly processed and integrated into the personal financial management and bill payment system.

This represents a significant and long standing technical problem in the financial management system, payment processing, and invoicing arts. In particular, currently available personal financial management and bill payment systems do not provide a mechanism for automatically identifying, or distinguishing, invoices, invoice data, and/or invoice payments and then properly processing and integrating identified invoices into a personal financial management and bill payment system.

As a result of the situation described above, many invoices are currently treated as bills and businesses generating invoices for their customers are not provided a mechanism to get invoices in front of their customers, have their invoices processed as the invoices they are, and/or integrate their invoices into the customers payment routine offered through the personal financial management and bill payment systems utilized by their customers. This situation exists today despite the fact that most businesses are business users of sophisticated business invoicing systems and/or business financial management systems that include business invoicing features.

Consequently, there is a long standing technical problem in the financial management system, payment processing, and invoicing arts in that currently available personal financial management and bill payment systems do not provide a mechanism for automatically identifying, or distinguishing, invoices, invoice data, and/or invoice payments and then properly processing and integrating identified invoices into a personal financial management and bill payment system.

What is needed is a method and system for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system.

To achieve this solution, in accordance with one embodiment, one or more processors associated with one or more computing systems are used to access the payee data and business user identification data and analyze the payee data and business user identification data to determine if a payee represented in the payee data matches a business user of the business invoicing system represented in the business user identification data.

In accordance with one embodiment, as a result of the analysis of the payee data and business user identification data, a first payee represented in the payee data that matches a first business user of the business invoicing system represented in the business user identification data is identified.

In one embodiment, the first payee is a payee associated with first financial transaction data representing a first financial transaction included in the personal financial management and bill payment system user financial transaction data associated with the user.

In accordance with one embodiment, once the first payee associated with the first financial transaction data representing the first financial transaction is identified as a business user of the business invoicing system, a status associated with the first financial transaction data representing the first financial transaction is transformed to first invoice related financial transaction data.

In accordance with one embodiment, the now identified first invoice related financial transaction data is processed as invoice related financial transaction data.

In accordance with one embodiment, the identified first business user/personal financial management and bill payment system user payee of the business invoicing system is provided the capability to provide invoicing data representing invoices generated by the first business user of the business invoicing system to the user of the personal financial management and bill payment system through the personal financial management and bill payment system.

In accordance with one embodiment, the identified first business user/personal financial management and bill payment system user payee of the business invoicing system is provided the capability and opportunity to have invoicing data representing invoices generated by the first business user of the business invoicing system processed by the personal financial management and bill payment system in the same way, or in a similar way, as any other bill or payment due is processed by the personal financial management and bill payment system.

In accordance with one embodiment, the identified first business user/personal financial management and bill payment system user payee of the business invoicing system is provided the capability and opportunity to have invoicing data representing invoices generated by the first business user of the business invoicing system be categorized using financial transaction categorizations used by the personal financial management and bill payment system in the same way, or in a similar way, as any other bill or payment due is processed by the personal financial management and bill payment system. In some of these embodiments, the first business user of the business invoicing system assigns a personal financial management and bill payment system financial transaction category to the invoices represented by the invoicing data automatically.

In accordance with one embodiment, the identified first business user/personal financial management and bill payment system user payee of the business invoicing system is provided the capability and opportunity to have invoicing data representing invoices generated by the first business user of the business invoicing system included as a listed payment due in a payments due report and/or display section of the personal financial management and bill payment system.

In accordance with one embodiment, the identified first business user/personal financial management and bill payment system user payee of the business invoicing system is provided the capability and opportunity to have invoicing data representing invoices generated by the first business user of the business invoicing system included as a listed payment due in a payments due report and/or display section of the personal financial management and bill payment system and the user of the personal financial management and bill payment system is provided the opportunity to pay the invoice using the same bill payment feature of the personal financial management and bill payment system used to pay any bill listed in the payments due section or display of the personal financial management and bill payment system.

Consequently, in one embodiment, once the first payee associated with the first financial transaction data representing the first financial transaction is identified as a first business user of the business invoicing system, the first business user of the business invoicing system is provided the capability and opportunity to have invoicing data representing invoices generated by the first business user of the business invoicing system fully integrated into the personal financial management and bill payment system and presented to the user of personal financial management and bill payment system in the same, or substantially similar, manner, as any other bill or payment due presented to the user of personal financial management and bill payment system.

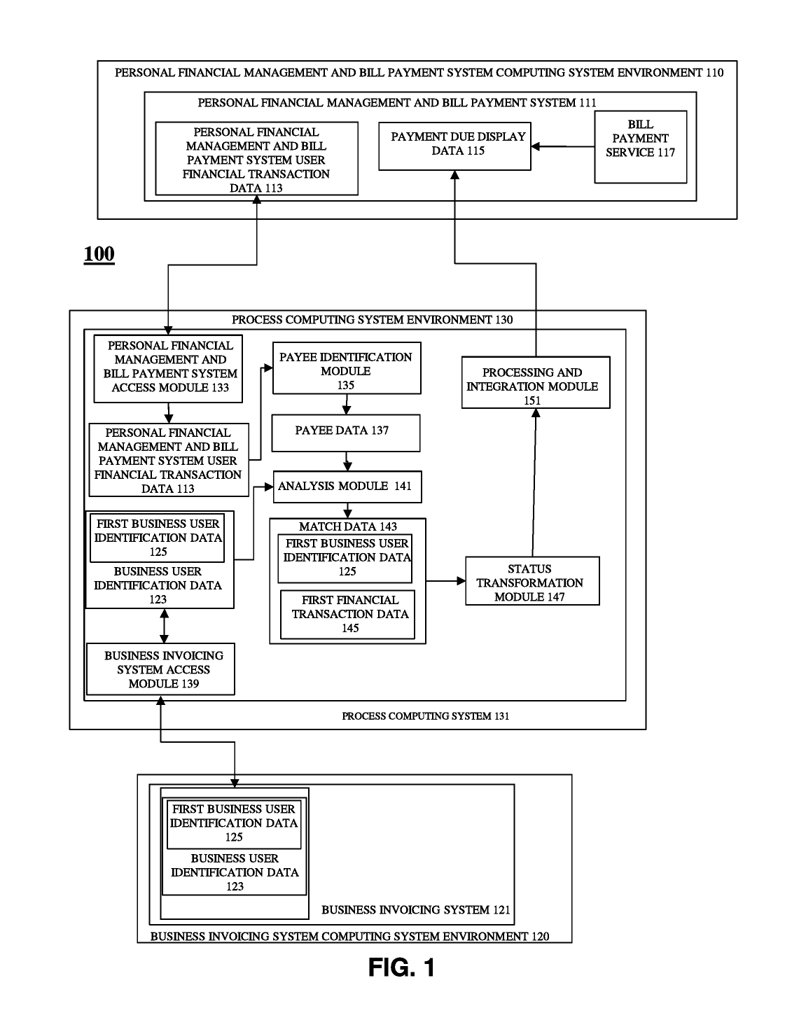

FIG. 1 is a high level functionality-based block diagram of a hardware and PRODUCTION ENVIRONMENT 100 for identifying invoices that are paid through a personal financial management and bill payment system, in accordance with one embodiment.

As seen in FIG. 1, in this specific illustrative example, PRODUCTION ENVIRONMENT 100 includes: PERSONAL FINANCIAL MANAGEMENT AND BILL PAYMENT SYSTEM COMPUTING SYSTEM ENVIRONMENT 110, including PERSONAL FINANCIAL MANAGEMENT AND BILL PAYMENT SYSTEM 111; BUSINESS INVOICING SYSTEM COMPUTING SYSTEM ENVIRONMENT 120, including BUSINESS INVOICING SYSTEM 121; and PROCESS COMPUTING SYSTEM ENVIRONMENT 130, including PROCESS COMPUTING SYSTEM 131.

As seen in FIG. 1, in this specific illustrative example, PERSONAL FINANCIAL MANAGEMENT AND BILL PAYMENT SYSTEM 111 includes PERSONAL FINANCIAL MANAGEMENT AND BILL PAYMENT SYSTEM USER FINANCIAL TRANSACTION DATA 113, PAYMENT DUE DISPLAY DATA 115, and BILL PAYMENT SERVICE 117.

As seen in FIG. 1, in this specific illustrative example, BUSINESS INVOICING SYSTEM 121 includes BUSINESS USER IDENTIFICATION DATA 123, including FIRST BUSINESS USER IDENTIFICATION DATA 125.

As seen in FIG. 1, in this specific illustrative example PROCESS COMPUTING SYSTEM 131 includes PERSONAL FINANCIAL MANAGEMENT AND BILL PAYMENT SYSTEM ACCESS MODULE 133, PAYEE IDENTIFICATION MODULE 135, PAYEE DATA 137, ANALYSIS MODULE 141, BUSINESS INVOICING SYSTEM ACCESS MODULE 139, BUSINESS USER IDENTIFICATION DATA 123 including FIRST BUSINESS USER IDENTIFICATION DATA 125, MATCH DATA 143, including FIRST BUSINESS USER IDENTIFICATION DATA 125 and FIRST FINANCIAL TRANSACTION DATA 145, STATUS TRANSFORMATION MODULE 147, and PROCESSING AND INTEGRATION MODULE 151.

In one embodiment PERSONAL FINANCIAL MANAGEMENT AND BILL PAYMENT SYSTEM ACCESS MODULE 133 is used to obtain access to PERSONAL FINANCIAL MANAGEMENT AND BILL PAYMENT SYSTEM USER FINANCIAL TRANSACTION DATA 113 representing financial transactions associated with users of PERSONAL FINANCIAL MANAGEMENT AND BILL PAYMENT SYSTEM 111.

In one embodiment, PAYEE IDENTIFICATION MODULE 135 is used to analyze PERSONAL FINANCIAL MANAGEMENT AND BILL PAYMENT SYSTEM USER FINANCIAL TRANSACTION DATA 113 associated with a given user to identify PAYEE DATA 137 included in PERSONAL FINANCIAL MANAGEMENT AND BILL PAYMENT SYSTEM USER FINANCIAL TRANSACTION DATA 113 associated with the user. In one embodiment, PAYEE DATA 137 represents one or more payees associated with the user financial transactions associated with the user represented by the user financial transaction data portion of PERSONAL FINANCIAL MANAGEMENT AND BILL PAYMENT SYSTEM USER FINANCIAL TRANSACTION DATA 113 associated with the user.

In one embodiment, BUSINESS INVOICING SYSTEM ACCESS MODULE 139 is used to obtain access to BUSINESS USER IDENTIFICATION DATA 123 associated with BUSINESS INVOICING SYSTEM 121. In one embodiment, BUSINESS USER IDENTIFICATION DATA 123 represents business users of BUSINESS INVOICING SYSTEM 121.

In one embodiment, ANALYSIS MODULE 141 is used for analyzing PAYEE DATA 137 and BUSINESS USER IDENTIFICATION DATA 123 to determine if a payee represented in PAYEE DATA 137 matches a business user of BUSINESS INVOICING SYSTEM 121 represented in BUSINESS USER IDENTIFICATION DATA 123.

In one embodiment, MATCH DATA 143 includes FIRST BUSINESS USER IDENTIFICATION DATA 125 representing an identified first payee represented in PAYEE DATA 137 that matches a first business user of BUSINESS INVOICING SYSTEM 121 represented in BUSINESS USER IDENTIFICATION DATA 123. In one embodiment, the first payee being a payee associated with FIRST FINANCIAL TRANSACTION DATA 145 representing a first financial transaction included in PERSONAL FINANCIAL MANAGEMENT AND BILL PAYMENT SYSTEM USER FINANCIAL TRANSACTION DATA 113 associated with the user.

In one embodiment, STATUS TRANSFORMATION MODULE 147 is used for transforming status data associated with FIRST FINANCIAL TRANSACTION DATA 145 representing the first financial transaction to first invoice related financial transaction data.

In one embodiment, PROCESSING AND INTEGRATION MODULE 151 is used for processing FIRST FINANCIAL TRANSACTION DATA 145 as invoice related financial transaction data and providing the first business user of the BUSINESS INVOICING SYSTEM 121 represented by FIRST BUSINESS USER IDENTIFICATION DATA 125 the capability to provide invoicing data representing invoices generated by the first business user of BUSINESS INVOICING SYSTEM 121 to the user of PERSONAL FINANCIAL MANAGEMENT AND BILL PAYMENT SYSTEM 111 PERSONAL FINANCIAL MANAGEMENT AND BILL PAYMENT SYSTEM 111.

The disclosed embodiments provide an efficient, effective, and dynamically adaptable method and system to solve the long standing technical problem of the inability of businesses to access personal financial management and bill payment systems used by their customers and provide invoices to their customers through the personal financial management and bill payment systems used by their customers.

However, the disclosed method and system for identifying invoices that are paid through a personal financial management and bill payment system does not encompass, embody, or preclude other forms of innovation in the area of automated financial transaction bill payment processing and invoicing. In addition, the disclosed method and system for identifying invoices that are paid through a personal financial management and bill payment system is not related to any fundamental economic practice, fundamental data processing practice, mental steps, or pen and paper based solution. In fact, the disclosed embodiments are directed to providing solutions to the relatively new problems associated with the automatic processing and display of electronic financial transaction data obtained from multiple sources, making electronic bill payments, and the management and processing of large amounts of data, i.e., “big data.” Consequently, the disclosed method and system for identifying invoices that are paid through a personal financial management and bill payment system is not directed to, does not encompass, and is not merely, an abstract idea or concept.

In addition, the disclosed method and system for identifying invoices that are paid through a personal financial management and bill payment system provides for significant improvements to the technical fields of electronic transaction data processing, financial transaction categorization, information dissemination, data processing, data management, data filtering and mining, automatic electronic bill payment, and user experience.

In addition, the disclosed method and system for identifying invoices that are paid through a personal financial management and bill payment system provides for the entry, processing, and dissemination, of only relevant portions of data; thereby eliminating unnecessary data analysis and correction before resources are allocated to processing, and/or correcting, faulty/irrelevant data, and/or the faulty/irrelevant data is further transmitted/distributed. Consequently, using the disclosed method and system for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing the method and system for identifying invoices that are paid through a personal financial management and bill payment system.

In addition, by allowing for the integration of invoices and invoice data into a personal financial management and bill payment system, the disclosed method and system for identifying invoices that are paid through a personal financial management and bill payment system helps users of the personal financial management and bill payment system identify and pay their invoices. This, in turn, helps avoid the reissuance and repeated transmission of payment due reminders and for the entry, processing, and dissemination, of redundant invoice data; thereby eliminating unnecessary data analysis before resources are allocated to processing, and/or correcting, redundant reminders data and the redundant reminder data is further transmitted/distributed. Consequently, using the disclosed method and system for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing the method and system for identifying invoices that are paid through a personal financial management and bill payment system.

### Process

In accordance with one embodiment, financial transaction data representing financial transactions associated with a user is obtained from, or through, a personal financial management and bill payment system. The financial transaction data is then analyzed to identify payee data representing the payees of financial transactions. The payee data is then compared with business user identification data representing users of a business invoicing system. If a match is found between a payee represented in the payee data and a business user represented in the business invoicing system, the associated payment is identified and processed as an invoice payment and the business user of the business invoicing system is provided the capability to provide invoicing data representing invoices generated by the business user to the user of the personal financial management and bill payment system through the personal financial management and bill payment system.

Consequently, disclosed herein is a method and system for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system. Therefore, disclosed herein is an efficient, effective, and dynamically adaptable technical solution to the long standing technical problem in the financial management system, payment processing, and invoicing arts of automatically identifying, or distinguishing, invoices and/or invoice payments and then properly processing and integrating identified invoices into a personal financial management and bill payment system.

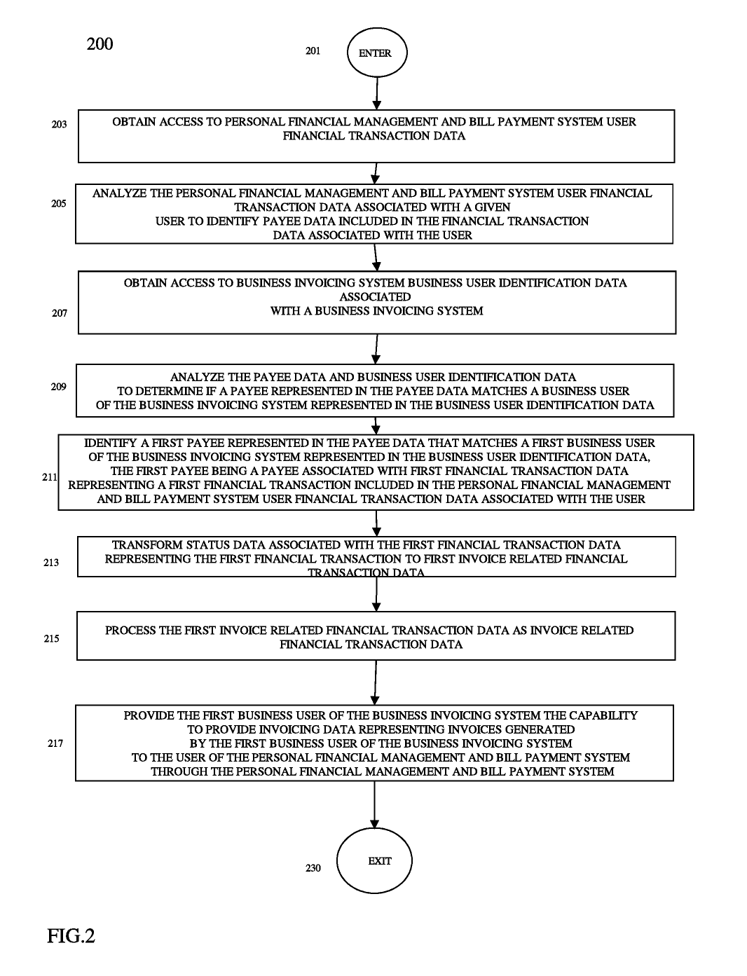

FIG. 2 is a flow chart representing one example of a process 200 for identifying invoices that are paid through a personal financial management and bill payment system in accordance with one embodiment.

As seen in FIG. 2, process 200 for identifying invoices that are paid through a personal financial management and bill payment system begins at ENTER OPERATION 201 and process flow proceeds to OBTAIN ACCESS TO PERSONAL FINANCIAL MANAGEMENT AND BILL PAYMENT SYSTEM USER FINANCIAL TRANSACTION DATA OPERATION 203.

In one embodiment, at OBTAIN ACCESS TO PERSONAL FINANCIAL MANAGEMENT AND BILL PAYMENT SYSTEM USER FINANCIAL TRANSACTION DATA OPERATION 203, one or more processors associated with one or more computing systems are utilized to obtain access to personal financial management and bill payment system user financial transaction data representing financial transactions associated with users of the personal financial management and bill payment system.

In one embodiment, a personal financial management and bill payment system is provided using one or more computing systems.

As noted above, herein, the term “personal financial management and bill payment system” includes, but is not limited to, the following: computing system, desktop system, mobile system, and/or wearable device implemented, and/or online, and/or web-based, storage based, persistence based, personal financial transaction aggregation and/or processing systems, services, packages, programs, modules, or applications; computing system, desktop system, mobile system, and/or wearable device implemented, and/or online, and/or web-based, storage based, persistence based, personal financial management and budgeting systems, services, packages, programs, modules, or applications; computing system, desktop system, mobile system, and/or wearable device implemented, and/or online, and/or web-based, storage based, persistence based, personal data management systems, services, packages, programs, modules, or applications; computing system, desktop system, mobile system, and/or wearable device implemented, and/or online, and/or web-based, storage based, persistence based, personal accounting systems, services, packages, programs, modules, or applications; personal electronic tax preparation systems, services, packages, programs, modules, or applications; and various other personal electronic data management systems, services, packages, programs, modules, or applications, whether known at the time of filling, or as developed later.

As noted above, specific examples of personal financial management and bill payment systems include, but are not limited to the following: Mint™, available from Intuit, Inc. of Mountain View, Calif.; Mint Online™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

In accordance with one embodiment, one or more processors associated with one or more computing systems are utilized to obtain access to personal financial management and bill payment system user financial transaction data representing financial transactions associated with users of the personal financial management and bill payment system at OBTAIN ACCESS TO PERSONAL FINANCIAL MANAGEMENT AND BILL PAYMENT SYSTEM USER FINANCIAL TRANSACTION DATA OPERATION 203.

As noted above, herein, the term “financial transaction” includes, but is not limited to, any interaction between two or more parties involving the transfer, or re-categorization, of funds between the parties. Herein, the term “financial transaction data” includes, but is not limited to, electronic data representing at least one financial transaction and that is capable of being processed by a processor, and/or stored in a memory, and/or is otherwise machine readable.

In accordance with one embodiment, at OBTAIN ACCESS TO PERSONAL FINANCIAL MANAGEMENT AND BILL PAYMENT SYSTEM USER FINANCIAL TRANSACTION DATA OPERATION 203 one or more processors associated with one or more computing systems are utilized to obtain access to personal financial management and bill payment system user financial transaction data associated with users of the personal financial management and bill payment system by obtaining access to user account data associated with the users of the personal financial management and bill payment system.

In various embodiments, the personal financial management and bill payment system user financial transaction data of OBTAIN ACCESS TO PERSONAL FINANCIAL MANAGEMENT AND BILL PAYMENT SYSTEM USER FINANCIAL TRANSACTION DATA OPERATION 203 includes, but is not limited to, payments made to a payee party on behalf of the user of the personal financial management and bill payment system through the personal financial management and bill payment system, and/or through any account offered by any financial institution of payment system provider.

In one embodiment, at OBTAIN ACCESS TO PERSONAL FINANCIAL MANAGEMENT AND BILL PAYMENT SYSTEM USER FINANCIAL TRANSACTION DATA OPERATION 203 the personal financial management and bill payment system user financial transaction data is verified as being associated with the users of the personal financial management and bill payment system using one or more verification mechanisms and/or processes as discussed herein, and/or as known in the art at the time of filing, and/or as developed or becomes known after the time of filing.

In one embodiment, at OBTAIN ACCESS TO PERSONAL FINANCIAL MANAGEMENT AND BILL PAYMENT SYSTEM USER FINANCIAL TRANSACTION DATA OPERATION 203 the personal financial management and bill payment system user financial transaction data obtained is stored in a partitioned personal financial management and bill payment system user financial transaction data section of a memory.

In one embodiment, once one or more processors associated with one or more computing systems are utilized to obtain access to personal financial management and bill payment system user financial transaction data representing financial transactions associated with users of the personal financial management and bill payment system at OBTAIN ACCESS TO PERSONAL FINANCIAL MANAGEMENT AND BILL PAYMENT SYSTEM USER FINANCIAL TRANSACTION DATA OPERATION 203, process flow proceeds to ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205.

In one embodiment, at ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205, one or more processors associated with one or more computing systems are used to analyze the personal financial management and bill payment system user financial transaction data associated with a given user of OBTAIN ACCESS TO PERSONAL FINANCIAL MANAGEMENT AND BILL PAYMENT SYSTEM USER FINANCIAL TRANSACTION DATA OPERATION 203 to identify user payee data included in the financial transaction data associated with the user.

In one embodiment, the user payee data of ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205 represents one or more payees associated with the user financial transactions associated with the user represented by the portion of the user financial transaction data associated with the user.

In one embodiment, at ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205 the user payee data is verified using one or more verification mechanisms and/or processes as discussed herein, and/or as known in the art at the time of filing, and/or as developed or becomes known after the time of filing.

In one embodiment, at ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205 the user payee data is stored in a partitioned user payee data section of a memory.

In one embodiment, once one or more processors associated with one or more computing systems are used to analyze the personal financial management and bill payment system user financial transaction data associated with a given user to identify user payee data included in the financial transaction data associated with the user at ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205, process flow proceeds to OBTAIN ACCESS TO BUSINESS INVOICING SYSTEM BUSINESS USER IDENTIFICATION DATA ASSOCIATED WITH A BUSINESS INVOICING SYSTEM OPERATION 207.

In one embodiment, at OBTAIN ACCESS TO BUSINESS INVOICING SYSTEM BUSINESS USER IDENTIFICATION DATA ASSOCIATED WITH A BUSINESS INVOICING SYSTEM OPERATION 207, one or more processors associated with one or more computing systems are utilized to obtain access to business invoicing system business user identification data associated with the business invoicing system. In one embodiment, the business user identification data represents business users of the business invoicing system. In one embodiment, the business user identification data is stored in a partitioned business user identification data section of a memory.

In accordance with one embodiment, a business invoicing system is provided to business users of the business invoicing system.

As noted above, herein, the term “business invoicing system” includes, but is not limited to, any system through which a business can generate, and/or submit, and/or process invoices requesting payment for products and/or services provided by the business to customers of the business. Therefore, the term “business invoicing system” includes, but is not limited to, the following: computing system, desktop system, mobile system, and/or wearable device implemented, and/or online, and/or web-based, storage based, persistence based, business accounting and/or invoicing systems, services, packages, programs, modules, or applications; computing system, desktop system, mobile system, and/or wearable device implemented, and/or online, and/or web-based, storage based, persistence based, business financial transaction aggregation and/or processing systems, services, packages, programs, modules, or applications; computing system, desktop system, mobile system, and/or wearable device implemented, and/or online, and/or web-based, storage based, persistence based, business financial management and budgeting systems, services, packages, programs, modules, or applications; computing system, desktop system, mobile system, and/or wearable device implemented, and/or online, and/or web-based, storage based, persistence based, business management systems, services, packages, programs, modules, or applications; business electronic tax preparation systems, services, packages, programs, modules, or applications; and various other business electronic data management systems, services, packages, programs, modules, or applications, whether known at the time of filling, or as developed later.

Specific examples of “business invoicing systems” include, but are not limited to, the following: QuickBooks™, available from Intuit, Inc. of Mountain View, Calif.; QuickBooks Online™, available from Intuit, Inc. of Mountain View, Calif.; QuickBooks Self-Employed™, available from Intuit, Inc. of Mountain View, Calif.; TurboTax™ available from Intuit, Inc. of Mountain View, Calif.; TurboTax Online™ available from Intuit, Inc. of Mountain View, Calif.; and/or various other software systems discussed herein, and/or known to those of skill in the art at the time of filing, and/or as developed after the time of filing.

Currently, personal financial management and bill payment systems and business invoicing systems are typically distinct software systems operated and/or used by two distinct parties, e.g., a customer of a business and an owner of a business, respectively. Therefore, currently, personal financial management and bill payment systems and business invoicing systems typically operate in isolation from each other, even when they are offered by the same personal financial management and bill payment system and business invoicing system provider.

As a specific illustrative example, in one embodiment, the personal financial management and bill payment system used by a customer of a business, or other user, could be a personal financial transaction management system such as Mint™, available from Intuit, Inc. of Mountain View, Calif. In this specific illustrative example, a business invoicing system, used by a business user, could be a business invoicing system such as QuickBooks™, available from Intuit, Inc. of Mountain View, Calif. As seen in this specific illustrative example, both the personal financial management and bill payment system and the business invoicing system are offered by the same software system provider, i.e., in this specific case, Intuit, Inc. of Mountain View, Calif. Consequently, according to one embodiment, in this specific illustrative example, the personal financial management and bill payment system and the business invoicing system are provided the opportunity to cross pollinate and cross confirm supported data. This approach has several unique advantages.

In some embodiments, the business invoicing system of OBTAIN ACCESS TO BUSINESS INVOICING SYSTEM BUSINESS USER IDENTIFICATION DATA ASSOCIATED WITH A BUSINESS INVOICING SYSTEM OPERATION 207 is part of, and/or a feature of, a parent small business financial management system.

In accordance with one embodiment, one or more processors associated with one or more computing systems are utilized to obtain access to business invoicing system business user identification data associated with the business invoicing system at OBTAIN ACCESS TO BUSINESS INVOICING SYSTEM BUSINESS USER IDENTIFICATION DATA ASSOCIATED WITH A BUSINESS INVOICING SYSTEM OPERATION 207.

In one embodiment, the business user identification data of OBTAIN ACCESS TO BUSINESS INVOICING SYSTEM BUSINESS USER IDENTIFICATION DATA ASSOCIATED WITH A BUSINESS INVOICING SYSTEM OPERATION 207 represents business users of the business invoicing system. In one embodiment, the business user identification data is stored in a partitioned business user identification data section of a memory.

In one embodiment, at OBTAIN ACCESS TO BUSINESS INVOICING SYSTEM BUSINESS USER IDENTIFICATION DATA ASSOCIATED WITH A BUSINESS INVOICING SYSTEM OPERATION 207 the business user identification data is verified using one or more verification mechanisms and/or processes as discussed herein, and/or as known in the art at the time of filing, and/or as developed or becomes known after the time of filing.

In one embodiment, once one or more processors associated with one or more computing systems are utilized to obtain access to business invoicing system business user identification data associated with the business invoicing system at OBTAIN ACCESS TO BUSINESS INVOICING SYSTEM BUSINESS USER IDENTIFICATION DATA ASSOCIATED WITH A BUSINESS INVOICING SYSTEM OPERATION 207, process flow proceeds to ANALYZE THE PAYEE DATA AND BUSINESS USER IDENTIFICATION DATA TO DETERMINE IF A PAYEE REPRESENTED IN THE PAYEE DATA MATCHES A BUSINESS USER OF THE BUSINESS INVOICING SYSTEM REPRESENTED IN THE BUSINESS USER IDENTIFICATION DATA OPERATION 209.

In one embodiment, at ANALYZE THE PAYEE DATA AND BUSINESS USER IDENTIFICATION DATA TO DETERMINE IF A PAYEE REPRESENTED IN THE PAYEE DATA MATCHES A BUSINESS USER OF THE BUSINESS INVOICING SYSTEM REPRESENTED IN THE BUSINESS USER IDENTIFICATION DATA OPERATION 209, one or more processors associated with one or more computing systems are used to access the payee data of ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205 and business user identification data of OBTAIN ACCESS TO BUSINESS INVOICING SYSTEM BUSINESS USER IDENTIFICATION DATA ASSOCIATED WITH A BUSINESS INVOICING SYSTEM OPERATION 207 and analyze the payee data and business user identification data to determine if a payee represented in the payee data matches a business user of the business invoicing system represented in the business user identification data.

As noted above, as used herein, the term “bill” includes, but is not limited to, an account statement or other recurring cost and financial transaction. Examples of bills include, but are not limited to: rent payments, utility payments, credit card payments, grocery store payments, vehicle costs, etc.

As also noted above, in contrast to the term “bill”, herein the term “invoice” includes, but is not limited to costs associated with a specific product and/or service provided by a business and for which full payment is requested via the invoice document. A given invoice is therefore typically a non-recurring expense and/or is associated with specific products and/or services rendered, even though multiple, and even recurring identical, invoices can be generated by the same business for the same customer if multiple products and/or services, even the same products and/or services, are provided.

As also noted above, herein the terms “payment” and/or “payment due” are used interchangeably and include any payment owed by a first party, i.e., a customer or payor party, to a second party, i.e., a business or payee party. Consequently, as used herein, the terms “payment” and/or “payment due” include both “bills” and “invoices.”

As also noted above, currently, a user of a personal financial management and bill payment system can pay both bills and invoices by simply entering payee data, amount data, routing data, and payment date. Consequently, users of a personal financial management and bill payment system can pay either bills or invoices without designating which type of payment is being made. This is unfortunate given the differences between “bills” and “invoices.” in terms of how these two types of payments should ideally be identified, categorized, and processed by the personal financial management and bill payment system. In short, it would be very beneficial to identify any invoices that are paid and, once identified, provide a feature whereby identified invoices generated by a business invoicing system, and/or one or more financial institutions providing financial transaction data to the personal financial management and bill payment system could be identified and then properly processed and integrated into the personal financial management and bill payment system.

This represents a significant and long standing technical problem in the financial management system, payment processing, and invoicing arts. In particular, currently available personal financial management and bill payment systems do not provide a mechanism for automatically identifying, or distinguishing, invoices, invoice data, and/or invoice payments and then properly processing and integrating identified invoices into a personal financial management and bill payment system.

As a result of the situation described above, many invoices are currently treated as bills and businesses generating invoices for their customers are not provided a mechanism to get invoices in front of their customers, have their invoices processed as the invoices they are, and/or integrate their invoices into the customers payment routine offered through the personal financial management and bill payment systems utilized by their customers. This situation exists today despite the fact that most businesses are business users of sophisticated business invoicing systems and/or business financial management systems that include business invoicing features.

Consequently, there is a long standing technical problem in the financial management system, payment processing, and invoicing arts in that currently available personal financial management and bill payment systems do not provide a mechanism for automatically identifying, or distinguishing, invoices, invoice data, and/or invoice payments and then properly processing and integrating identified invoices into a personal financial management and bill payment system.

What is needed is a method and system for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system.

To achieve this solution, in accordance with one embodiment, at ANALYZE THE PAYEE DATA AND BUSINESS USER IDENTIFICATION DATA TO DETERMINE IF A PAYEE REPRESENTED IN THE PAYEE DATA MATCHES A BUSINESS USER OF THE BUSINESS INVOICING SYSTEM REPRESENTED IN THE BUSINESS USER IDENTIFICATION DATA OPERATION 209 one or more processors associated with one or more computing systems are used to access the payee data and business user identification data and analyze the payee data and business user identification data to determine if a payee represented in the payee data matches a business user of the business invoicing system represented in the business user identification data.

In one embodiment, once one or more processors associated with one or more computing systems are used to access the payee data and business user identification data and analyze the payee data and business user identification data to determine if a payee represented in the payee data matches a business user of the business invoicing system represented in the business user identification data at ANALYZE THE PAYEE DATA AND BUSINESS USER IDENTIFICATION DATA TO DETERMINE IF A PAYEE REPRESENTED IN THE PAYEE DATA MATCHES A BUSINESS USER OF THE BUSINESS INVOICING SYSTEM REPRESENTED IN THE BUSINESS USER IDENTIFICATION DATA OPERATION 209, process flow proceeds to IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211.

In one embodiment, at IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211, a first payee represented in the payee data that matches a first business user of the business invoicing system represented in the business user identification data is identified.

In accordance with one embodiment, as a result of the analysis of the payee data and business user identification data at ANALYZE THE PAYEE DATA AND BUSINESS USER IDENTIFICATION DATA TO DETERMINE IF A PAYEE REPRESENTED IN THE PAYEE DATA MATCHES A BUSINESS USER OF THE BUSINESS INVOICING SYSTEM REPRESENTED IN THE BUSINESS USER IDENTIFICATION DATA OPERATION 209, a first payee represented in the payee data that matches a first business user of the business invoicing system represented in the business user identification data is identified at IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211.

In one embodiment, the first payee of IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211 is a payee associated with first financial transaction data representing a first financial transaction included in the personal financial management and bill payment system user financial transaction data associated with the user of ANALYZE THE PERSONAL FINANCIAL MANAGEMENT AND BILL PAYMENT SYSTEM USER FINANCIAL TRANSACTION DATA ASSOCIATED WITH A GIVEN USER TO IDENTIFY PAYEE DATA INCLUDED IN THE FINANCIAL TRANSACTION DATA ASSOCIATED WITH THE USER OPERATION 205.

In one embodiment, once a first payee represented in the payee data that matches a first business user of the business invoicing system represented in the business user identification data is identified at IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211, process flow proceeds to TRANSFORM STATUS DATA ASSOCIATED WITH THE FIRST FINANCIAL TRANSACTION DATA REPRESENTING THE FIRST FINANCIAL TRANSACTION TO FIRST INVOICE RELATED FINANCIAL TRANSACTION DATA OPERATION 213.

In one embodiment, once the first payee associated with the first financial transaction data representing the first financial transaction is identified as a business user of the business invoicing system at IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211, a status associated with the first financial transaction data representing the first financial transaction is transformed to first invoice related financial transaction data at TRANSFORM STATUS DATA ASSOCIATED WITH THE FIRST FINANCIAL TRANSACTION DATA REPRESENTING THE FIRST FINANCIAL TRANSACTION TO FIRST INVOICE RELATED FINANCIAL TRANSACTION DATA OPERATION 213.

In one embodiment, once a status associated with the first financial transaction data representing the first financial transaction is transformed to first invoice related financial transaction data at TRANSFORM STATUS DATA ASSOCIATED WITH THE FIRST FINANCIAL TRANSACTION DATA REPRESENTING THE FIRST FINANCIAL TRANSACTION TO FIRST INVOICE RELATED FINANCIAL TRANSACTION DATA OPERATION 213, process flow proceeds to PROCESS THE FIRST INVOICE RELATED FINANCIAL TRANSACTION DATA AS INVOICE RELATED FINANCIAL TRANSACTION DATA OPERATION 215.

In one embodiment, once a status associated with the first financial transaction data representing the first financial transaction is transformed to first invoice related financial transaction data at TRANSFORM STATUS DATA ASSOCIATED WITH THE FIRST FINANCIAL TRANSACTION DATA REPRESENTING THE FIRST FINANCIAL TRANSACTION TO FIRST INVOICE RELATED FINANCIAL TRANSACTION DATA OPERATION 213, the now identified first invoice related financial transaction data is processed as invoice related financial transaction data at PROCESS THE FIRST INVOICE RELATED FINANCIAL TRANSACTION DATA AS INVOICE RELATED FINANCIAL TRANSACTION DATA OPERATION 215.

In one embodiment, once the now identified first invoice related financial transaction data is processed as invoice related financial transaction data at PROCESS THE FIRST INVOICE RELATED FINANCIAL TRANSACTION DATA AS INVOICE RELATED FINANCIAL TRANSACTION DATA OPERATION 215, process flow proceeds to PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217.

In one embodiment, once the now identified first invoice related financial transaction data is processed as invoice related financial transaction data at PROCESS THE FIRST INVOICE RELATED FINANCIAL TRANSACTION DATA AS INVOICE RELATED FINANCIAL TRANSACTION DATA OPERATION 215, the identified first business user/personal financial management and bill payment system user payee of the business invoicing system of IDENTIFY A FIRST PAYEE REPRESENTED IN THE PAYEE DATA THAT MATCHES A FIRST BUSINESS USER OF THE BUSINESS INVOICING SYSTEM REPRESENTED IN THE BUSINESS USER IDENTIFICATION DATA, THE FIRST PAYEE BEING A PAYEE ASSOCIATED WITH FIRST FINANCIAL TRANSACTION DATA REPRESENTING A FIRST FINANCIAL TRANSACTION INCLUDED IN THE PERSONAL FINANCIAL MANAGEMENT AND BILL PAYMENT SYSTEM USER FINANCIAL TRANSACTION DATA ASSOCIATED WITH THE USER OPERATION 211 is provided the capability to provide invoicing data representing invoices generated by the first business user of the business invoicing system to the user of the personal financial management and bill payment system through the personal financial management and bill payment system of OBTAIN ACCESS TO PERSONAL FINANCIAL MANAGEMENT AND BILL PAYMENT SYSTEM USER FINANCIAL TRANSACTION DATA OPERATION 203 at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217.

In accordance with one embodiment, at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217 the identified first business user/personal financial management and bill payment system user payee of the business invoicing system is provided the capability to provide invoicing data representing invoices generated by the first business user of the business invoicing system to the user of the personal financial management and bill payment system through the personal financial management and bill payment system.

In accordance with one embodiment, at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217 the identified first business user/personal financial management and bill payment system user payee of the business invoicing system is provided the capability and opportunity to have invoicing data representing invoices generated by the first business user of the business invoicing system processed by the personal financial management and bill payment system in the same way, or in a similar way, as any other bill or payment due is processed by the personal financial management and bill payment system.

In accordance with one embodiment, at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217 the identified first business user/personal financial management and bill payment system user payee of the business invoicing system is provided the capability and opportunity to have invoicing data representing invoices generated by the first business user of the business invoicing system be categorized using financial transaction categorizations used by the personal financial management and bill payment system in the same way, or in a similar way, as any other bill or payment due is processed by the personal financial management and bill payment system. In some of these embodiments, the first business user of the business invoicing system assigns a personal financial management and bill payment system financial transaction category to the invoices represented by the invoicing data automatically.

In accordance with one embodiment, at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217 the identified first business user/personal financial management and bill payment system user payee of the business invoicing system is provided the capability and opportunity to have invoicing data representing invoices generated by the first business user of the business invoicing system included as a listed payment due in a payments due report and/or display section of the personal financial management and bill payment system.

In accordance with one embodiment, at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217 the identified first business user/personal financial management and bill payment system user payee of the business invoicing system is provided the capability and opportunity to have invoicing data representing invoices generated by the first business user of the business invoicing system included as a listed payment due in a payments due report and/or display section of the personal financial management and bill payment system and the user of the personal financial management and bill payment system is provided the opportunity to pay the invoice using the same bill payment feature of the personal financial management and bill payment system used to pay any bill listed in the payments due section or display of the personal financial management and bill payment system.

In one embodiment, once the identified first business user/personal financial management and bill payment system user payee of the business invoicing system is provided the capability to provide invoicing data representing invoices generated by the first business user of the business invoicing system to the user of the personal financial management and bill payment system through the personal financial management and bill payment at PROVIDE THE FIRST BUSINESS USER OF THE BUSINESS INVOICING SYSTEM THE CAPABILITY TO PROVIDE INVOICING DATA REPRESENTING INVOICES GENERATED BY THE FIRST BUSINESS USER OF THE BUSINESS INVOICING SYSTEM TO THE USER OF THE PERSONAL FINANCIAL MANAGEMENT AND BILL PAYMENT SYSTEM THROUGH THE PERSONAL FINANCIAL MANAGEMENT AND BILL PAYMENT SYSTEM OPERATION 217, process flow proceeds to EXIT OPERATION 230.

In one embodiment, at EXIT OPERATION 230, process 200 for identifying invoices that are paid through a personal financial management and bill payment system is exited to await new data.

The disclosed embodiments of process 200 for identifying invoices that are paid through a personal financial management and bill payment system provide for automatically identifying, or distinguishing, invoices, invoice data, and/or invoice payments and then properly processing and integrating identified invoices into a personal financial management and bill payment system and providing a business the capability to provide their invoices to customer users of a personal financial management and bill payment system through the personal financial management and bill payment system. Therefore, disclosed herein is an efficient, effective, and dynamically adaptable technical solution to the long standing technical problem in the financial management system, payment processing, and invoicing arts of automatically identifying, or distinguishing, invoices and/or invoice payments and then properly processing and integrating identified invoices into a personal financial management and bill payment system.

However, process 200 for identifying invoices that are paid through a personal financial management and bill payment system does not encompass, embody, or preclude other forms of innovation in the area of automated financial transaction bill payment processing and invoicing. In addition, process 200 for identifying invoices that are paid through a personal financial management and bill payment system is not related to any fundamental economic practice, fundamental data processing practice, mental steps, or pen and paper based solution. In fact, process 200 for identifying invoices that are paid through a personal financial management and bill payment system is directed to providing a solution to the relatively new problems associated with the automatic processing and display of electronic financial transaction data obtained from multiple sources, making electronic bill payments, and the management and processing of large amounts of data, i.e., “big data.” Consequently, process 200 for identifying invoices that are paid through a personal financial management and bill payment system is not directed to, does not encompass, and is not merely, an abstract idea or concept.

In addition, process 200 for identifying invoices that are paid through a personal financial management and bill payment system provides for significant improvements to the technical fields of electronic transaction data processing, financial transaction categorization, information dissemination, data processing, data management, data filtering and mining, automatic electronic bill payment, and user experience.

In addition, process 200 for identifying invoices that are paid through a personal financial management and bill payment system provides for the entry, processing, and dissemination, of only relevant portions of data; thereby eliminating unnecessary data analysis and correction before resources are allocated to processing, and/or correcting, faulty/irrelevant data, and/or the faulty/irrelevant data is further transmitted/distributed. Consequently, using process 200 for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing process 200 for identifying invoices that are paid through a personal financial management and bill payment system.

In addition, by allowing for the integration of invoices and invoice data into a personal financial management and bill payment system, process 200 for identifying invoices that are paid through a personal financial management and bill payment system helps users of the personal financial management and bill payment system identify and pay their invoices. This, in turn, helps avoid the reissuance and repeated transmission of payment due reminders and for the entry, processing, and dissemination, of redundant invoice data; thereby eliminating unnecessary data analysis before resources are allocated to processing, and/or correcting, redundant reminders data and the redundant reminder data is further transmitted/distributed. Consequently, using process 200 for identifying invoices that are paid through a personal financial management and bill payment system results in more efficient use of human and non-human resources, fewer processor cycles being utilized, reduced memory utilization, and less communications bandwidth being utilized to relay data to, and from, backend systems and client systems. As a result, computing systems are transformed into faster, more efficient, and more effective computing systems by implementing process 200 for identifying invoices that are paid through a personal financial management and bill payment system.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein, are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the mechanism and/or process used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “monitoring,” “determining,” “defining,” “designating,” “obtaining,” “accessing,” “analyzing,” “obtaining,” “identifying,” “designating,” categorizing,” “receiving,” “transmitting,” “implementing,” “associating,” “aggregating,” “initiating,” “collecting,” “creating,” “transferring,” “storing,” “searching,” “comparing,” “providing,” “transforming,” “incorporating.” “processing” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes by a computer program stored via a computer program product as defined herein that can be accessed by a computing system or other device to transform the computing system or other device into a specifically and specially programmed computing system or other device.

Those of skill in the art will readily recognize that the algorithms and operations presented herein are not inherently related to any particular computing system, computer architecture, computer or industry standard, or any other specific apparatus. It may prove convenient/efficient to construct or transform one or more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

In the discussion above, certain aspects of one embodiment include process steps and/or operations and/or instructions described herein for illustrative purposes in a particular order and/or grouping. However, the particular order and/or grouping shown and discussed herein is illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein does not limit the scope of the invention as claimed below.

Therefore, numerous variations, whether explicitly provided for by the specification or implied by the specification or not, may be implemented by one of skill in the art in view of this disclosure.

What is claimed is:

1. A method for identifying invoices that are paid through a personal financial management and bill payment system, the method comprising:
obtaining access to personal financial management and bill payment system user financial transaction data representing financial transactions associated with users of a personal financial management and bill payment system, the personal financial management and bill payment system user financial transaction data being stored in a partitioned personal financial management and bill payment system user financial transaction data section of a memory;
analyzing the personal financial management and bill payment system user financial transaction data associated with a given user to identify payee data included in the financial transaction data associated with the user, the payee data representing one or more payees associated with the user financial transactions associated with the user represented by the portion of the user financial transaction data associated with the user;
storing the payee data in a partitioned user payee data section of a memory;
obtaining access to business invoicing system business user identification data associated with a business invoicing system, the business user identification data representing business users of the business invoicing system, the business user identification data being stored in a partitioned business user identification data section of a memory;
accessing the payee data in the partitioned user payee data section of a memory and the business user identification data in the partitioned business user identification data section of a memory;
analyzing the payee data and business user identification data to determine if a payee represented in the payee data matches a business user of the business invoicing system represented in the business user identification data;
identifying a first payee represented in the payee data that matches a first business user of the business invoicing system represented in the business user identification data, the first payee being a payee associated with first financial transaction data representing a first financial transaction included in the personal financial management and bill payment system user financial transaction data associated with the user;
transforming status data associated with the first financial transaction data representing the first financial transaction to first invoice related financial transaction data;
processing the first invoice related financial transaction data as invoice related financial transaction data; and
providing the first business user of the business invoicing system the capability to provide invoicing data representing invoices generated by the first business user of the business invoicing system to the user of the personal financial management and bill payment system through the personal financial management and bill payment system.

2. The method for identifying invoices that are paid through a personal financial management and bill payment system of claim 1, wherein the personal financial management and bill payment system is a financial transaction management and billing system through which a user of the financial transaction management and billing system is provided the capability to categorize financial transactions and pay the customer user's bills.

3. The method for identifying invoices that are paid through a personal financial management and bill payment system of claim 1, wherein the business invoicing system is part of a small business financial management and bill payment system.

4. The method for identifying invoices that are paid through a personal financial management and bill payment system of claim 1, wherein obtaining access to business invoicing system business user identification data includes obtaining access to business user accounts data associated with business users of the business invoicing system.

5. The method for identifying invoices that are paid through a personal financial management and bill payment system of claim 1, wherein identifying a first payee represented in the payee data that matches a first business user of the business invoicing system represented in the business user identification data includes verifying the first payee represented in the payee data.

6. The method for identifying invoices that are paid through a personal financial management and bill payment system of claim 1, wherein identifying a first payee represented in the payee data that matches a first business user of the business invoicing system represented in the business user identification data includes verifying the first business user of the business invoicing system represented in the business user identification data.

7. The method for identifying invoices that are paid through a personal financial management and bill payment system of claim 1 wherein processing the first invoice related financial transaction data as invoice related financial transaction data includes assigning a personal financial management and bill payment system financial transaction category to the invoices generated by the first business user of the business invoicing system.

8. The method for identifying invoices that are paid through a personal financial management and bill payment system of claim 1 wherein providing the first business user of the business invoicing system the capability to provide invoicing data representing invoices generated by the first business user of the business invoicing system to the user of the personal financial management and bill payment system through the personal financial management and bill payment system includes providing the invoicing data representing invoices generated by first business user to the first customer as a line item in a bills due for payment listing generated through the personal financial management and bill payment system.

9. A system for identifying invoices that are paid through a personal financial management and bill payment system comprising:
a personal financial management and bill payment system;
a business invoicing system;
a personal financial management and bill payment system access module for obtaining access to personal financial management and bill payment system user financial transaction data representing financial transactions associated with users of a personal financial management and bill payment system, the personal financial management and bill payment system user financial transaction data being stored in a partitioned personal financial management and bill payment system user financial transaction data section of a memory;
a payee identification module for analyzing the personal financial management and bill payment system user financial transaction data associated with a given user to identify payee data included in the financial transaction data associated with the user, the payee data representing one or more payees associated with the user financial transactions associated with the user represented by the portion of the user financial transaction data associated with the user;
a business invoicing system access module for obtaining access to business invoicing system business user identification data associated with a business invoicing system, the business user identification data representing business users of the business invoicing system, the business user identification data being stored in a partitioned business user identification data section of a memory;
an analysis module for analyzing the payee data and business user identification data to determine if a payee represented in the payee data matches a business user of the business invoicing system represented in the business user identification data;
match data representing an identified first payee represented in the payee data that matches a first business user of the business invoicing system represented in the business user identification data, the first payee being a payee associated with first financial transaction data representing a first financial transaction included in the personal financial management and bill payment system user financial transaction data associated with the user;
a status transformation module for transforming status data associated with the first financial transaction data representing the first financial transaction to first invoice related financial transaction data; and
a processing and integration module for processing the first invoice related financial transaction data as invoice related financial transaction data and providing the first business user of the business invoicing system the capability to provide invoicing data representing invoices generated by the first business user of the business invoicing system to the user of the personal financial management and bill payment system through the personal financial management and bill payment system.

10. The system for identifying invoices that are paid through a personal financial management and bill payment system of claim 9, wherein the personal financial management and bill payment system is a financial transaction management and billing system through which a user of the financial transaction management and billing system is provided the capability to categorize financial transactions and pay the customer user's bills.

11. The system for identifying invoices that are paid through a personal financial management and bill payment system of claim 9, wherein the business invoicing system is part of a small business financial management and bill payment system.

12. The system for identifying invoices that are paid through a personal financial management and bill payment system of claim 9, wherein obtaining access to business invoicing system business user identification data includes obtaining access to business user accounts data associated with business users of the business invoicing system.

13. The system for identifying invoices that are paid through a personal financial management and bill payment system of claim 9, wherein identifying a first payee represented in the payee data that matches a first business user of the business invoicing system represented in the business user identification data includes verifying the first payee represented in the payee data.

14. The system for identifying invoices that are paid through a personal financial management and bill payment system of claim 9, wherein identifying a first payee represented in the payee data that matches a first business user of the business invoicing system represented in the business user identification data includes verifying the first business user of the business invoicing system represented in the business user identification data.

15. The system for identifying invoices that are paid through a personal financial management and bill payment system of claim 9, wherein processing the first invoice related financial transaction data as invoice related financial transaction data includes assigning a personal financial management and bill payment system financial transaction category to the invoices generated by the first business user of the business invoicing system.

16. The system for identifying invoices that are paid through a personal financial management and bill payment system of claim 9, wherein providing the first business user of the business invoicing system the capability to provide invoicing data representing invoices generated by the first business user of the business invoicing system to the user of the personal financial management and bill payment system through the personal financial management and bill payment system includes providing the invoicing data representing invoices generated by first business user to the first customer as a line item in a bills due for payment listing generated through the personal financial management and bill payment system.

17. A computer program product for identifying invoices that are paid through a personal financial management and bill payment system, the computer program product including machine readable instructions for implementing a process for identifying invoices that are paid through a personal financial management and bill payment system, the process for identifying invoices that are paid through a personal financial management and bill payment system comprising:
obtaining access to personal financial management and bill payment system user financial transaction data representing financial transactions associated with users of a personal financial management and bill payment system, the personal financial management and bill payment system user financial transaction data being stored in a partitioned personal financial management and bill payment system user financial transaction data section of a memory;
analyzing the personal financial management and bill payment system user financial transaction data associated with a given user to identify payee data included in the financial transaction data associated with the user, the payee data representing one or more payees associated with the user financial transactions associated with the user represented by the portion of the user financial transaction data associated with the user;
storing the payee data in a partitioned user payee data section of a memory;
obtaining access to business invoicing system business user identification data associated with a business invoicing system, the business user identification data representing business users of the business invoicing system, the business user identification data being stored in a partitioned business user identification data section of a memory;
accessing the payee data in the partitioned user payee data section of a memory and the business user identification data in the partitioned business user identification data section of a memory;
analyzing the payee data and business user identification data to determine if a payee represented in the payee data matches a business user of the business invoicing system represented in the business user identification data;
identifying a first payee represented in the payee data that matches a first business user of the business invoicing system represented in the business user identification data, the first payee being a payee associated with first financial transaction data representing a first financial transaction included in the personal financial management and bill payment system user financial transaction data associated with the user;
transforming status data associated with the first financial transaction data representing the first financial transaction to first invoice related financial transaction data;
processing the first invoice related financial transaction data as invoice related financial transaction data; and
providing the first business user of the business invoicing system the capability to provide invoicing data representing invoices generated by the first business user of the business invoicing system to the user of the personal financial management and bill payment system through the personal financial management and bill payment system.

18. The computer program product for identifying invoices that are paid through a personal financial management and bill payment system of claim 17, wherein the personal financial management and bill payment system is a financial transaction management and billing system through which a user of the financial transaction management and billing system is provided the capability to categorize financial transactions and pay the customer user's bills.

19. The computer program product for identifying invoices that are paid through a personal financial management and bill payment system of claim 17, wherein the business invoicing system is part of a small business financial management and bill payment system.

20. The computer program product for identifying invoices that are paid through a personal financial management and bill payment system of claim 17, wherein obtaining access to business invoicing system business user identification data includes obtaining access to business user accounts data associated with business users of the business invoicing system.

21. The computer program product for identifying invoices that are paid through a personal financial management and bill payment system of claim 17, wherein identifying a first payee represented in the payee data that matches a first business user of the business invoicing system represented in the business user identification data includes verifying the first payee represented in the payee data.

22. The computer program product for identifying invoices that are paid through a personal financial management and bill payment system of claim 17, wherein identifying a first payee represented in the payee data that matches a first business user of the business invoicing system represented in the business user identification data includes verifying the first business user of the business invoicing system represented in the business user identification data.

23. The computer program product for identifying invoices that are paid through a personal financial management and bill payment system of claim 17 wherein processing the first invoice related financial transaction data as invoice related financial transaction data includes assigning a personal financial management and bill payment system financial transaction category to the invoices generated by the first business user of the business invoicing system.

24. The computer program product for identifying invoices that are paid through a personal financial management and bill payment system of claim 17 wherein providing the first business user of the business invoicing system the capability to provide invoicing data representing invoices generated by the first business user of the business invoicing system to the user of the personal financial management and bill payment system through the personal financial management and bill payment system includes providing the invoicing data representing invoices generated by first business user to the first customer as a line item in a bills due for payment listing generated through the personal financial management and bill payment system.
